(19) United States
(12) Patent Application Publication
(10) Pub. No.: US 2013/0019585 A1
(43) Pub. Date: Jan. 24, 2013

(54) VARIABLE FAN INLET GUIDE VANE FOR TURBINE ENGINE

(71) Applicants: Brian Merry, Andover, CT (US); Gabriel L. Suciu, Glastonbury, CT (US); James W. Norris, Lebanon, CT (US); Steven J. Sirica, Ellington, CT (US); Frederick M. Schwarz, Glastonbury, MI (US)

(72) Inventors: Brian Merry, Andover, CT (US); Gabriel L. Suciu, Glastonbury, CT (US); James W. Norris, Lebanon, CT (US); Steven J. Sirica, Ellington, CT (US); Frederick M. Schwarz, Glastonbury, MI (US)

(21) Appl. No.: 13/340,909

(22) Filed: Dec. 30, 2011

Related U.S. Application Data
(63) Continuation-in-part of application No. 13/022,456, filed on Feb. 7, 2011, now Pat. No. 8,276,362.
Application No. 13/022,456 is a division of application No. 11/719,143, filed on May 11, 2007, now Pat. No. 7,882,694.

(51) Int. Cl. F02K 3/04

(52) U.S. Cl. 60/226.3; 60/726

(57) ABSTRACT

A turbine engine includes a compressor section, a combustor arranged in fluid-receiving communication with the compressor section, a turbine section arranged in fluid-receiving communication with the combustor and a gearbox assembly coupled to be driven by the turbine section. The gearbox assembly is located at an axial position that is aft of the compressor section.

### CROSS REFERENCE TO RELATED APPLICATIONS

The present disclosure is a continuation in part of U.S. patent application Ser. No. 13/022,456, filed Feb. 7, 2011, which is a divisional of U.S. Ser. No. 11/719,143, filed May 11, 2007, now U.S. Pat. No. 7,882,694.

### STATEMENT REGARDING FEDERALLY SPONSORED RESEARCH OR DEVELOPMENT

This invention was conceived in performance of U.S. Air Force contract F33657-03-C-2044. The government may have rights in this invention.

### BACKGROUND OF THE INVENTION

The present invention relates to turbine engines, and more particularly to a variable fan inlet guide vane for a turbine engine, such as a tip turbine engine.

An aircraft gas turbine engine of the conventional turbofan type generally includes a forward bypass fan, a low pressure compressor, a middle core engine, and an aft low pressure turbine, all located along a common longitudinal axis. A high pressure compressor and a high pressure turbine of the core engine are interconnected by a high spool shaft. The high pressure compressor is rotatably driven to compress air entering the core engine to a relatively high pressure. This high pressure air is then mixed with fuel in a combustor, where it is ignited to form a high energy gas stream. The gas stream flows axially aft to rotatably drive the high pressure turbine, which rotatably drives the high pressure compressor via the high spool shaft. The gas stream leaving the high pressure turbine is expanded through the low pressure turbine, which rotatably drives the bypass fan and low pressure compressor via a low spool shaft.

Although highly efficient, conventional turbofan engines operate in an axial flow relationship. The axial flow relationship results in a relatively complicated elongated engine structure of considerable length relative to the engine diameter. This elongated shape may complicate or prevent packaging of the engine into particular applications.

A recent development in gas turbine engines is the tip turbine engine. Tip turbine engines may include a low pressure axial compressor directing core airflow into hollow fan blades. The hollow fan blades operate as a centrifugal compressor when rotating. Compressed core airflow from the hollow fan blades is mixed with fuel in an annular combustor, where it is ignited to form a high energy gas stream which drives the turbine that is integrated onto the tips of the hollow bypass fan blades for rotation therewith as generally disclosed in U.S. Patent Application Publication Nos.: 20030192303; 20030192304; and 20040025490. The tip turbine engine provides a thrust-to-weight ratio equivalent to or greater than conventional turbofan engines of the same class, but within a package of significantly shorter length.

Some low bypass ratio conventional turbine engines include variable fan inlet guide vanes. The variable fan inlet guide vanes each include a pivotably mounted flap. The trailing edges of the flaps are all connected via activation levers to a unison ring about the outer circumference of the flaps, such that rotation of the unison ring causes the flaps to pivot uniformly. Generally, high bypass ratio turbine engines (i.e. with a bypass ratio greater than three) do not include variable fan inlet guide vanes.

### SUMMARY OF THE INVENTION

A turbine engine according to a non-limiting exemplary embodiment includes a compressor section, a combustor arranged in fluid-receiving communication with the compressor section, a turbine section arranged in fluid-receiving communication with the combustor and a gearbox assembly coupled to be driven by the turbine section, the gearbox assembly being located at an axial position that is aft of the compressor section.

In a further embodiment of the foregoing turbine engine the axial position of the gearbox assembly is aft of the turbine section.

In further embodiment of the foregoing turbine engine, the turbine section includes a plurality of rotatable turbine blades and a plurality of static turbine stators.

In further embodiment of foregoing turbine engine the compressor section includes an axial compressor.

In a further embodiment of the foregoing turbine engine the gearbox assembly is an epicyclic gearbox.

In a further embodiment of the foregoing turbine engine the gearbox assembly is mounted on a gearbox bearing.

In a further embodiment of the foregoing turbine engine the gearbox assembly is configured to provide a speed decrease.

In a further embodiment of the foregoing turbine engine the gearbox assembly defines a reduction ratio of about 3.34:1.

In a further embodiment of the foregoing turbine engine, the gearbox assembly defines a reduction ratio greater than or equal to about 3.34:1

In a further embodiment of the foregoing turbine engine the turbine section is coupled to drive the compressor section through the gearbox assembly.

In a further embodiment of the foregoing turbine engine the turbine engine has a high bypass ratio.

In a further embodiment of the foregoing turbine engine the turbine engine has a bypass ratio of at least five.

In a further embodiment of the foregoing turbine engine, the turbine engine has a bypass ratio greater than about ten (10).

A turbine engine according to another non-limiting exemplary embodiment includes a compressor section, a combustor arranged in fluid receiving communication with the compressor section, a turbine section arranged in fluid receiving communication with the combustor, and a gearbox assembly coupled to be driven by the turbine section, the gearbox assembly being located at an axial position that is aft of the turbine section.

In a further embodiment of the foregoing turbine engine the turbine section includes a plurality of rotatable turbine blades and a plurality of static turbine stators.

In a further embodiment of the foregoing turbine engine the compressor section includes an axial compressor.

In a further embodiment of the foregoing turbine engine, the gearbox assembly is an epicyclic gearbox.

In a further embodiment of the foregoing turbine engine the gearbox assembly is mounted on a gearbox bearing.

In a further embodiment of the foregoing turbine engine the gearbox assembly is configured to provide a speed decrease.

In a further embodiment of the foregoing turbine engine, the gearbox assembly defines a gear reduction ratio of about 3.34:1

In a further embodiment of the foregoing turbine engine the gearbox assembly defines a gear reduction ratio of greater than or equal to 3.34:1.

In a further embodiment of foregoing turbine engine the turbine section is coupled to drive the compressor section through the gearbox assembly.

In a further embodiment of the foregoing turbine engine the turbine engine has a high bypass ratio.

In a further embodiment of the foregoing turbine engine the turbine engine has a bypass ratio of at least five.

In a further embodiment of the foregoing turbine engine, the turbine engine has a bypass ratio greater than or equal to about ten (10).

Although different examples have the specific components shown in the illustrations, embodiments of this invention are not limited to those particular combinations. It is possible to use some of the components or features from one of the examples in combination with features or components of another of the examples.

These and other features disclosed herein can be best understood from the following specification and drawings, the following of which is a brief description

### BRIEF DESCRIPTION OF THE DRAWINGS

Other advantages of the present invention can be understood by reference to the following detailed description when considered in connection with the accompanying drawings wherein:

FIG. 1 is a partial sectional perspective view of a tip turbine engine.

FIG. 2 is a longitudinal sectional view of the tip turbine engine of FIG. 1 along an engine centerline and a schematic view of an engine controller.

### DETAILED DESCRIPTION OF THE PREFERRED EMBODIMENTS

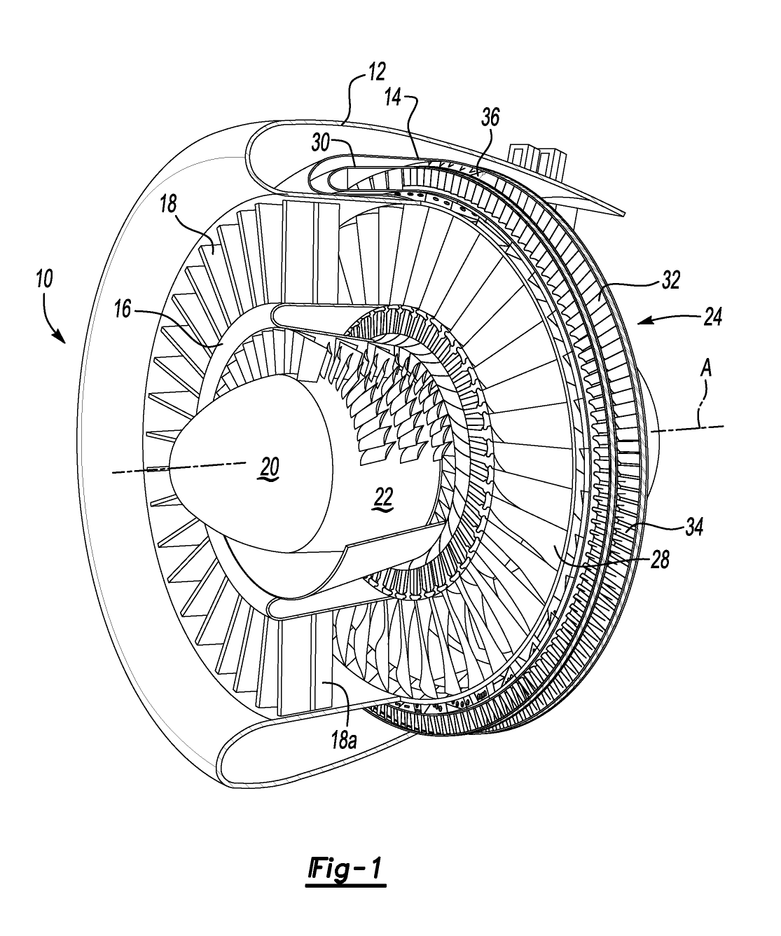

FIG. 1 illustrates a general perspective partial sectional view of a tip turbine engine (TTE) type gas turbine engine 10. The engine 10 includes an outer nacelle 12, a rotationally fixed static outer support structure 14 and a rotationally fixed static inner support structure 16. A plurality of fan inlet guide vanes 18 are mounted between the static outer support structure 14 and the static inner support structure 16. Each fan inlet guide vane preferably includes a pivotable flap 18A. A nosecone 20 is preferably located along the engine centerline A to improve airflow into an axial compressor 22, which is mounted about the engine centerline A behind the nosecone 20.

A fan-turbine rotor assembly 24 is mounted for rotation about the engine centerline A aft of the axial compressor 22. The fan-turbine rotor assembly 24 includes a plurality of hollow fan blades 28 to provide internal, centrifugal compression of the compressed airflow from the axial compressor 22 for distribution to an annular combustor 30 located within the rotationally fixed static outer support structure 14.

A turbine 32 includes a plurality of tip turbine blades 34 (two stages shown) which rotatably drive the hollow fan blades 28 relative a plurality of tip turbine stators 36 which extend radially inwardly from the rotationally fixed static outer support structure 14. The annular combustor 30 is disposed axially forward of the turbine 32 and communicates with the turbine 32.

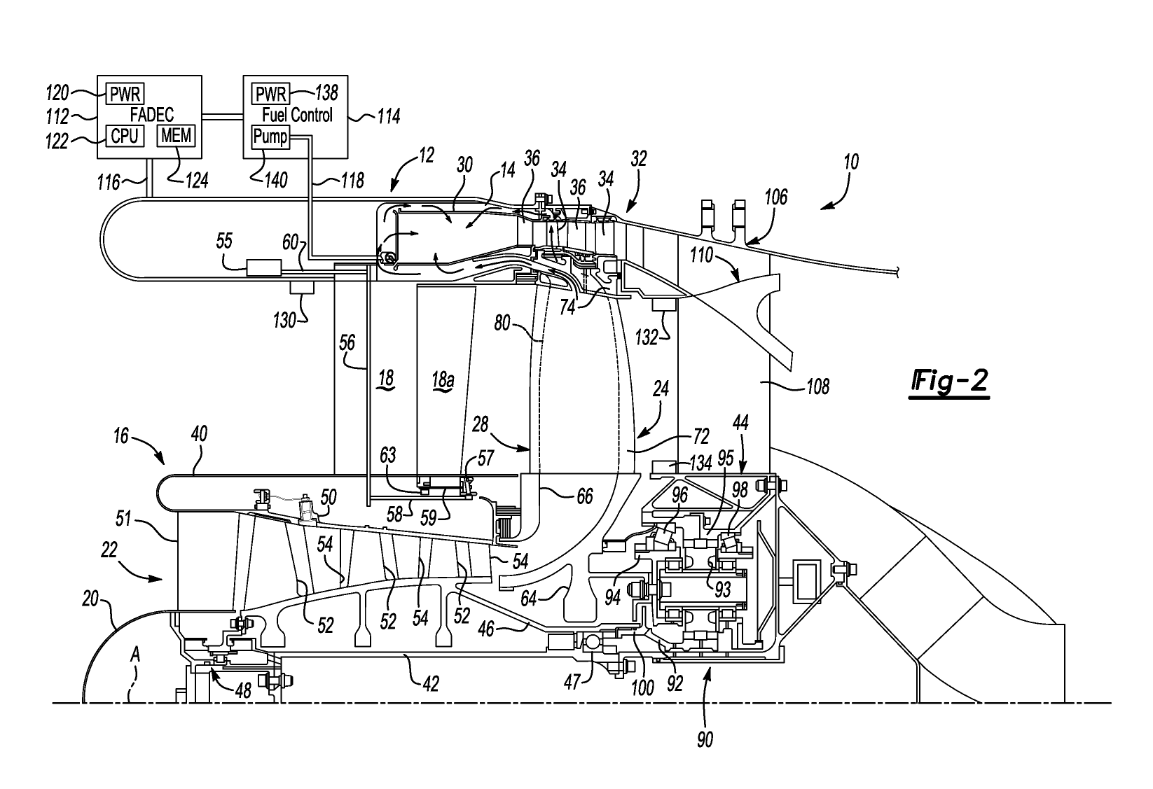

Referring to FIG. 2, the rotationally fixed static inner support structure 16 includes a splitter 40, a static inner support housing 42 and a static outer support housing 44 located coaxial to said engine centerline A.

The axial compressor 22 includes the axial compressor rotor 46, which is mounted for rotation upon the static inner support housing 42 through an aft bearing assembly 47 and a forward bearing assembly 48. A plurality of compressor blades 52 extends radially outwardly from the axial compressor rotor 46. A fixed compressor case 50 is mounted within the splitter 40. The axial compressor 22 includes a plurality of inlet guide vanes 51 (one shown). For reasons explained below, it is not necessary to provide a variable inlet geometry to the axial compressor 22. Therefore, the inlet guide vane 51 is fixed, thereby reducing the weight and complexity of the axial compressor 22.

A plurality of compressor vanes 54 extends radially inwardly from the compressor case 50 between stages of the compressor blades 52. The compressor blades 52 and compressor vanes 54 are arranged circumferentially about the axial compressor rotor 46 in stages (three stages of compressor blades 52 and compressor vanes 54 are shown in this example).

The rotational position of the fan inlet guide vane flap 18A is controlled by an actuator 55 that is mounted within the nacelle 12, radially outwardly of one of the fan inlet guide vanes 18 and radially outward of the bypass airflow path. The actuator 55 may be hydraulic, electric motor or linear actuator, or any other type of suitable actuator. The actuator 55 is operatively connected to the fan inlet guide vane flaps 18A via a torque rod 56 that is routed through one of the inlet guide vanes 18. Within the splitter 40, the torque rod 56 is coupled to a unison ring 57 via a torque rod lever 58. The unison ring 57 is rotatable about the engine centerline A. The unison ring 57 is coupled to a shaft 63 of the variable guide vane flap 18a via an activation lever 59. The plurality of variable guide vanes 18 and flaps 18a (only one shown) are disposed circumferentially about the engine centerline A, and each is connected to the unison ring 57 in the same manner. The actuator 55 is coupled to the torque rod 56 by an actuator lever 60.

The fan-turbine rotor assembly 24 includes a fan hub 64 that supports a plurality of the hollow fan blades 28. Each fan blade 28 includes an inducer section 66, a hollow fan blade section 72 and a diffuser section 74. The inducer section 66 receives airflow from the axial compressor 22 generally parallel to the engine centerline A and turns the airflow from an axial airflow direction toward a radial airflow direction. The airflow is radially communicated through a core airflow passage 80 within the fan blade section 72 where the airflow is centrifugally compressed. From the core airflow passage 80, the airflow is diffused and turned once again by the diffuser section 74 toward an axial airflow direction toward the annular combustor 30. Preferably, the airflow is diffused axially forward in the engine 10, however, the airflow may alternatively be communicated in another direction.

The tip turbine engine 10 may optionally include a gearbox assembly 90 aft of the fan-turbine rotor assembly 24, such that the fan-turbine rotor assembly 24 rotatably drives the axial compressor 22 via the gearbox assembly 90. In the embodiment shown, the gearbox assembly 90 provides a speed increase at a 3.34-to-one ratio. The gearbox assembly 90 is an epicyclic gearbox, such as a planetary gearbox as shown, that is mounted for rotation between the static inner support housing 42 and the static outer support housing 44. The gearbox assembly 90 includes a sun gear 92, which rotates the axial compressor rotor 46, and a planet carrier 94, which rotates with the fan-turbine rotor assembly 24. A plurality of planet gears 93 each engage the sun gear 92 and a rotationally fixed ring gear 95. The planet gears 93 are mounted to the planet carrier 94. The gearbox assembly 90 is mounted for rotation between the sun gear 92 and the static outer support housing 44 through a gearbox forward bearing 96 and a gearbox rear bearing 98. The gearbox assembly 90 may alternatively, or additionally, reverse the direction of rotation and/or may provide a decrease in rotation speed.

A plurality of exit guide vanes 108 are located between the static outer support housing 44 and the rotationally fixed exhaust case 106 to guide the combined airflow out of the engine 10. An exhaust mixer 110 mixes the airflow from the turbine blades 34 with the bypass airflow through the fan blades 28.

An upstream pressure sensor 130 measures pressure upstream of the fan blades 28 and a downstream pressure sensor 132 measures pressure downstream of the fan blades 28. A rotation speed sensor 134 is mounted adjacent the fan blades 28 to determine the rotation speed of the fan blades 28. The rotation speed sensor 134 may be a proximity sensor detecting the passage of each fan blade 28 to calculate the rate of rotation.

Control of the tip turbine engine 10 is provided by a Full Authority Digital Engine Controller (FADEC) 112 and by a fuel controller 114, both mounted remotely from the tip turbine engine 10 (i.e. outside the nacelle 12) and connected to the tip turbine engine 10 by a single wiring harness 116 and a single fuel line 118, respectively. The FADEC 112 includes a power source 120 such as a battery, a fuel cell, or other electric generator. The FADEC 112 includes a CPU 122 and memory 124 for executing control algorithms to generate control signals to the tip turbine engine 10 and the fuel controller 114 based upon input from the upstream pressure sensor 130, the downstream pressure sensor 132 and the rotation speed sensor 134. The control signals may include signals for controlling the position of the flaps 18A of the fan inlet guide vanes 18, commands that are sent to the fuel controller 114 to indicate the amount of fuel that should be supplied and other necessary signals for controlling the tip turbine engine 10.

The fuel controller 114 also includes a power source 138, such as a battery, fuel cell, or other electric generator. The fuel controller 114 includes at least one fuel pump 140 for controlling the supply of fuel to the tip turbine engine 10 via fuel line 118.

During operation, core airflow enters the axial compressor 22, where it is compressed by the compressor blades 52. The compressed air from the axial compressor 22 enters the inducer section 66 in a direction generally parallel to the engine centerline A, and is then turned by the inducer section 66 radially outwardly through the core airflow passage 80 of the hollow fan blades 28. The airflow is further compressed centrifugally in the hollow fan blades 28 by rotation of the hollow fan blades 28. From the core airflow passage 80, the airflow is turned and diffused axially forward in the engine 10 by the diffuser section 74 into the annular combustor 30. The compressed core airflow from the hollow fan blades 28 is mixed with fuel in the annular combustor 30 and ignited to form a high-energy gas stream.

The high-energy gas stream is expanded over the plurality of tip turbine blades 34 mounted about the outer periphery of the fan-turbine rotor assembly 24 to drive the fan-turbine rotor assembly 24, which in turn rotatably drives the axial compressor 22 either directly or via the optional gearbox assembly 90. The fan-turbine rotor assembly 24 discharges fan bypass air axially aft to merge with the core airflow from the turbine 32 in the exhaust case 106.

The FADEC 112 controls bypass air flow and impingement angle by varying the fan inlet guide vane flaps 18A based upon information in signals from the upstream pressure sensor 130, the downstream pressure sensor 132 and the rotation speed sensor 134. The sensors 130, 132, 134 indicate a current operating state of the tip turbine engine 10. The FADEC 112 determines a desired operating state for the tip turbine engine 10 and generates control signals to bring the tip turbine engine 10 toward the desired operating state. These control signals include control signals for varying the fan inlet guide vanes 18.

Closing the fan inlet guide vane flaps 18A during starting of the tip turbine engine 10 reduces the starter power requirements, while maintaining core airflow. During operation, the FADEC 112 controls the axial compressor 22 operability and stability margin by varying the fan inlet guide vane flaps 18A. In the tip turbine engine 10, the fan blades 28 are coupled to the axial compressor 22 at a fixed rate via the gearbox 90 (or, alternatively, directly). Therefore, slowing the rotation of the fan blades 28 by closing the fan inlet guide vane flaps 18A slows rotation of the axial compressor 22. Additionally, controllably slowing down rotation of the fan blades 28 also reduces the centrifugal compression of the core airflow in the fan blades 28 heading toward the combustor 30, which thereby reduces the output of the combustor 30 and the force with which the turbine 32 is rotated. By significantly altering the speed-flow relationship of the primary propulsor, the combustor temperature relationship changes in a way that allows control of the primary compressor operating lines. This is driven by the relationship between compressor exit corrected flow and high-pressure turbine inlet corrected flow. In typical gas turbine engines, the high-pressure turbine is typically choked and operates at a constant inlet corrected flow. This combined with the fact that flow is usually proportional to speed and combustor temperature ratio is typically constant drives primary compressors to require some sort of variable geometry or bleed to maintain stability. By altering the fan speed-flow characteristic through use of the fan variable inlet guide vanes 18, one can significantly alter the combustor temperature ratio, thereby controlling the primary compressor operating lines and establishing stability without compressor variable geometry or bleed.

FIGS. 1 and 2 are generally scale drawings. The tip turbine engine 10 shown is a high-bypass ratio turbine engine, with a bypass ratio of 5.0. In one disclosed, non-limiting embodiment, the engine 10 defines a bypass ratio greater than about six (6), with an example embodiment being greater than about ten (10).

Thrust is a function of density, velocity, and area. Low pressure ratio turbofans are desirable for their high propulsive efficiency. A significant amount of thrust is provided by the bypass flow due to the high bypass ratio. Typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method steps are for ease of reference in dependent claims and do not signify a required sequence of performance unless otherwise indicated.

1. A turbine engine comprising:
a compressor section;
a combustor arranged in fluid-receiving communication with the compressor section;
a turbine section arranged in fluid-receiving communication with the combustor; and
a gearbox assembly coupled to be driven by the turbine section, the gearbox assembly being located at an axial position that is aft of the compressor section.

2. The turbine engine as recited in claim 1, wherein the axial position of the gearbox assembly is aft of the turbine section.

3. The turbine engine as recited in claim 2, wherein the turbine section includes a plurality of rotatable turbine blades and a plurality of static turbine stators.

4. The turbine engine as recited in claim 1, wherein the compressor section includes an axial compressor.

5. The turbine engine as recited in claim 1, wherein the gearbox assembly is an epicyclic gearbox.

6. The turbine engine as recited in claim 1, wherein the gearbox assembly is mounted on a gearbox bearing.

7. The turbine engine as recited in claim 1, wherein the gearbox assembly is configured to provide a speed decrease.

8. The turbine engine as recited in claim 7, wherein the gearbox assembly defines a reduction ratio of about 3.34:1.

9. The turbine engine as recited in claim 7, wherein the gearbox assembly defines a reduction ratio greater than or equal to about 3.34:1

10. The turbine engine as recited in claim 1, wherein the turbine section is coupled to drive the compressor section through the gearbox assembly.

11. The turbine engine as recited in claim 1, wherein the turbine engine has a high bypass ratio.

12. The turbine engine as recited in claim 1, wherein the turbine engine has a bypass ratio of at least five.

13. The turbine engine as recited in claim 1, wherein the turbine engine has a bypass ratio greater than about ten (10).

14. A turbine engine comprising:
a compressor section;
a combustor arranged in fluid receiving communication with the compressor section;
a turbine section arranged in fluid receiving communication with the combustor; and
a gearbox assembly coupled to be driven by the turbine section, the gearbox assembly being located at an axial position that is aft of the turbine section.

15. The turbine engine as recited in claim 11, wherein the turbine section includes a plurality of rotatable turbine blades and a plurality of static turbine stators.

16. The turbine engine as recited in claim 11, wherein the compressor section includes an axial compressor.

17. The turbine engine as recited in claim 11, wherein the gearbox assembly is an epicyclic gearbox.

18. The turbine engine as recited in claim 11, wherein the gearbox assembly is mounted on a gearbox bearing.

19. The turbine engine as recited in claim 11, wherein the gearbox assembly is configured to provide a speed decrease.

20. The turbine engine as recited in claim 19, wherein the gearbox assembly defines a gear reduction ratio of about 3.34:1

21. The turbine engine as recited in claim 19, wherein the gearbox assembly defines a gear reduction ratio of greater than or equal to 3.34:1.

22. The turbine engine as recited in claim 11, wherein the turbine section is coupled to drive the compressor section through the gearbox assembly.

23. The turbine engine as recited in claim 11, wherein the turbine engine has a high bypass ratio.

24. The turbine engine as recited in claim 11, wherein the turbine engine has a bypass ratio of at least five (5).

25. The turbine engine as recited in claim 11, wherein the turbine engine has a bypass ratio greater than or equal to about ten (10)
